(19) United States
(12) Patent Application Publication
(10) Pub. No.: US 2014/0070593 A1
(43) Pub. Date: Mar. 13, 2014

(54) INFLATABLE SEAT AND METHOD OF USE

(71) Applicants: Peter Stephen Hughes, South Harwich, MA (US); Paul Anthony Gaudette, New Bedford, MA (US)

(72) Inventors: Peter Stephen Hughes, South Harwich, MA (US); Paul Anthony Gaudette, New Bedford, MA (US)

(73) Assignee: VECTRIX INTERNATIONAL LIMITED, Kwai Chung (HK)

(21) Appl. No.: 13/608,266

(22) Filed: Sep. 10, 2012

(51) Int. Cl. B60N 2/44; A47C 7/14

(52) U.S. Cl. 297/452.41

(57) ABSTRACT

An inflatable seat system includes one or more seats having a seat base; an inner layer on the seat base; and an outer layer extending over the inner layer. At least one of the inner layer and the outer layer define a plurality of vertically layered inflatable bladders that are individually adjustably inflatable to adjust one or more of height, width, and firmness in the seat system.

### FIELD OF THE INVENTION

The present invention relates to inflatable seats for vehicles.

### BACKGROUND OF THE INVENTION

Seats for riders and passengers of two-wheeled vehicles and three-wheeled vehicles (e.g., scooters) have generally been of fixed shape and firmness. Since riders and passengers come in all shapes and sizes, the ability to adjust the seat height, width and firmness is advantageous.

### SUMMARY OF THE INVENTION

An aspect of the invention involves an inflatable seat system including a plurality of air inflatable bladders that can be used to adjust height, width, firmness of both the rider and passenger seats with each seat having its own unique set of characteristics. The system includes two or more vertically layered or stacked air bladders that are used to adjust the height and feel of the seat by means of the air pressure in each bladder. The system includes one or more inflation and deflation mechanisms in the form of individual valves for each bladder and/or a series of manually operated selector switches to select height, width, and firmness. The valves and switches are preferably located under the seat so as not to be exposed (e.g., hidden in the trunk). Both a forward rider seat and a rear passenger seat would preferably have their own controls (i.e., individually adjustable). The seat cover material includes a fabric flexible enough to expand and contract with the inflation and deflation combination of the bladders which make up the seat. The seats have a conventional plastic base upon which the horizontal and vertical bladders would be secured to make up the seat.

Advantages of vertically layering or stacking the bladders include the following: provides for an initial “course” adjustment for height, width, and firmness from the inner layer; provides for fine tuning height, width, firmness from the outer layer; inner layer(s) can be pneumatic (air) and outer layer(s) can be a number of items including one or more of air, nitrogen, gel, and foam; in a further embodiment, once the seat is fitted to the rider, a quick setting foam material is inserted to solidify the customized seat, making the seat configuration permanent if so desired; the adjustments in the individual bladders may be saved in memory and stored for future use. A rider can punch in his/her profile code and the seat automatically inflates/forms to the rider's profile.

Another aspect of the invention involves an inflatable seat system. The inflatable seat system includes one or more seats having a seat base; an inner layer on the seat base; and an outer layer extending over the inner layer. At least one of the inner layer and the outer layer define a plurality of vertically layered inflatable bladders that are individually adjustably inflatable to adjust one or more of height, width, and firmness in the seat system.

One or more implementations of the aspect of the invention described immediately above include one or more of the following: the inflatable seat system includes one or more inflation and deflation mechanisms to individually adjustably inflate and deflate the plurality of vertically layered inflatable bladders; the one or more inflation and deflation mechanisms are located under the seat base; the one or more seats include a forward rider seat and a rear passenger seat; the outer layer includes fabric material flexible enough to expand and contract with the inflation and deflation of the bladders; the inner layer defines the plurality of vertically layered inflatable bladders for providing a coarse adjustment for at one or more of height, width, and firmness of the seat; the plurality of vertically layered inflatable bladders defined by the inner layer are pneumatic; the outer layer defines the plurality of vertically layered inflatable bladders for providing a fine adjustment for one or more of height, width, and firmness of the seat; the one or more vertically layered inflatable bladders defined by the outside layer include one or more of air, nitrogen, gel, and foam; the inflatable seat system includes an electronic control system having memory and wherein adjustments in the plurality of vertically layered inflatable bladders are saved in memory and stored for future use; the inflatable seat system includes an input device that a rider can input a rider's profile into so that the seat automatically inflates or deflates to the rider's profile; the inner layer defines the plurality of vertically layered inflatable bladders for providing a coarse adjustment for one or more of height, width, and firmness of the seat and the outer layer defines one or more vertically layered inflatable bladders for providing a fine adjustment for one or more of height, width, and firmness of the seat; and/or the inner layer includes a single inflatable bladder for coarse adjustment of one or more of height, width, and firmness of the seat and the outer layer includes a single inflatable bladder for fine adjustment of one or more of height, width, and firmness of the seat.

### BRIEF DESCRIPTION OF THE DRAWINGS

FIG. 1 is a top plan view of an embodiment of a seat system constructed in accordance with an embodiment of the invention;

FIG. 2A is cross-sectional view of the seat system of FIG. 1 taken along line A-A of FIG. 1;

FIG. 2B is cross-sectional view similar to that shown in FIG. 2A, but of an alternative embodiment of a seat system including a passenger backrest;

FIG. 2C is cross-sectional view similar to that shown in FIG. 2B, but of a further embodiment of a seat system including a passenger backrest;

FIG. 3A is a cross-sectional view of the seat system of FIG. 1 taken along line B-B of FIG. 1;

FIG. 3B is a cross-sectional view of the seat system of FIG. 1 taken along line C-C of FIG. 1;

FIG. 4 is a top plan view of an additional embodiment of a seat system;

FIG. 5A is cross-sectional view of the seat system of FIG. 4 taken along line A-A of FIG. 4;

FIG. 5B is cross-sectional view similar to that shown in FIG. 5A, but of an alternative embodiment of a seat system;

FIG. 6A is a cross-sectional view of the seat system of FIG. 4 taken along line B-B of FIG. 4;

FIG. 6B is a cross-sectional view of the seat system of FIG. 4 taken along line C-C of FIG. 4;

FIG. 7A is a cross-sectional view of the seat system of FIG. 5B, similar to the FIG. 6A view;

FIG. 7B is a cross-sectional view of the seat system of FIG. 5B, similar to the FIG. 6B view;

FIG. 8A is cross-sectional view similar to that shown in FIG. 5B, and shows valves and switches underneath the seat system to select height, width, and firmness of each bladder in the seat system;

FIG. 8B is a top plan view of the valves and switches underneath the seat system to select height, width, and firmness of each bladder in the seat system; and

FIG. 8C is an enlarged top plan and schematical view of the valves and switches to select height, width, and firmness of each bladder in the seat system.

### DETAILED DESCRIPTION OF THE PREFERRED EMBODIMENTS

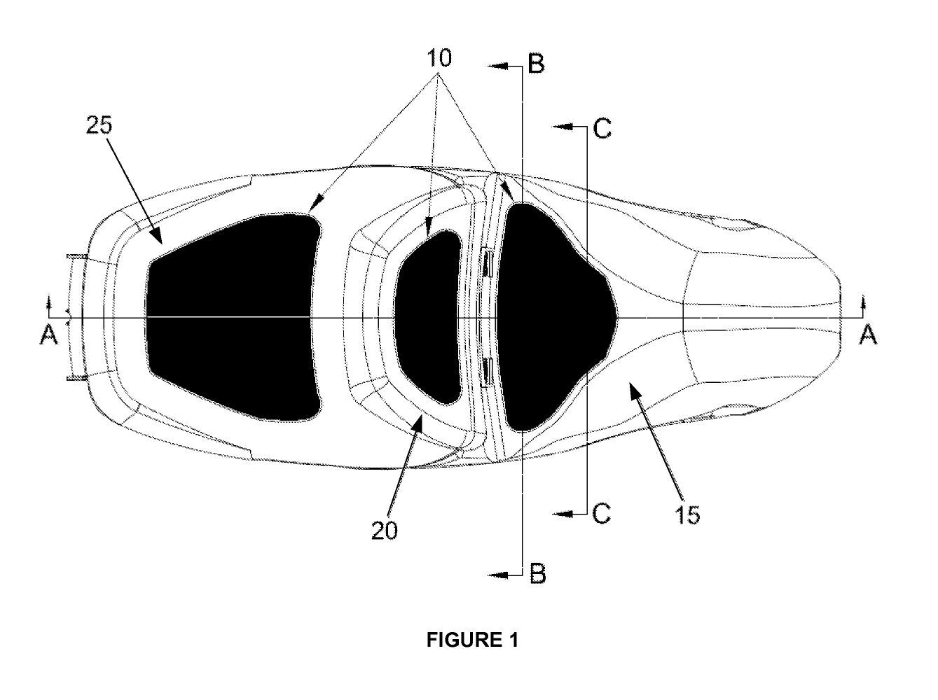

With reference to FIGS. 1-9, an inflatable seat system 10 constructed in accordance with an embodiment of the invention will be described. The inflatable seat system 10 will be shown and described as an inflatable seat system 10 for a vehicle and, in particular, a motorcycle or scooter seat. In alternative, embodiments, the inflatable seat system 10 may be used in other applications.

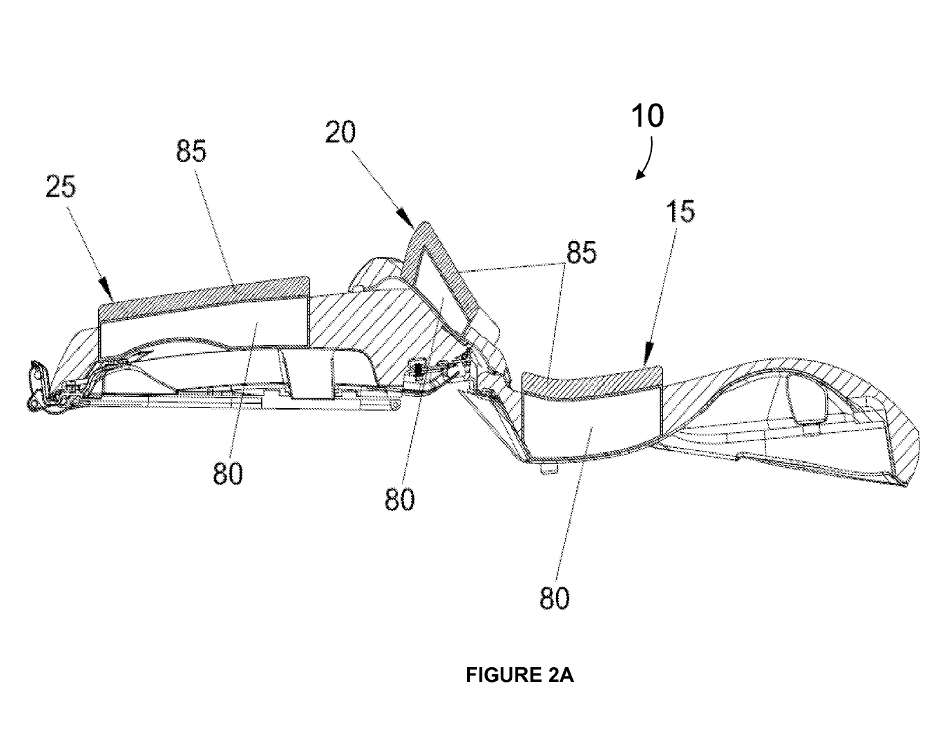

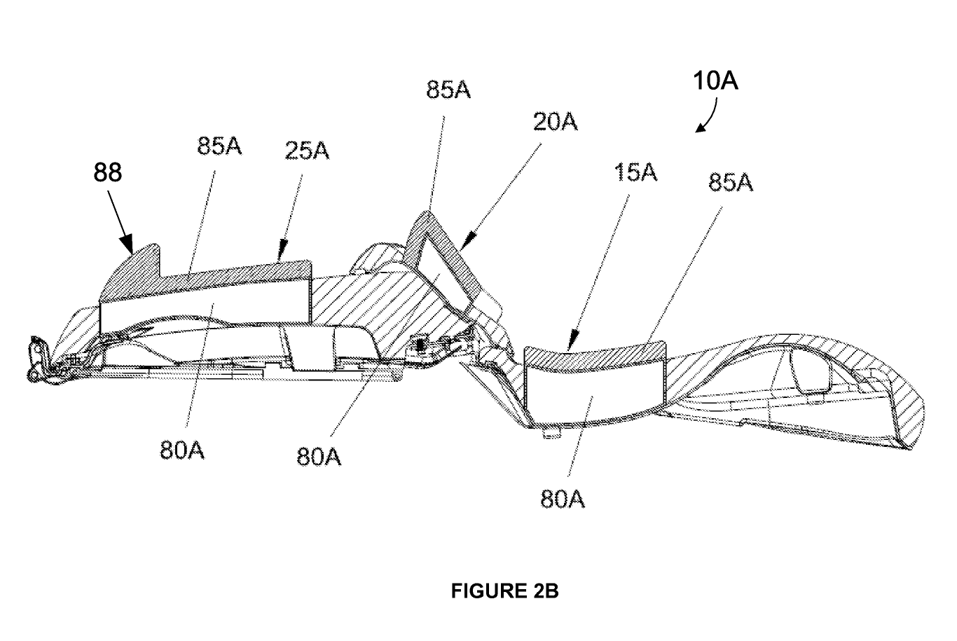

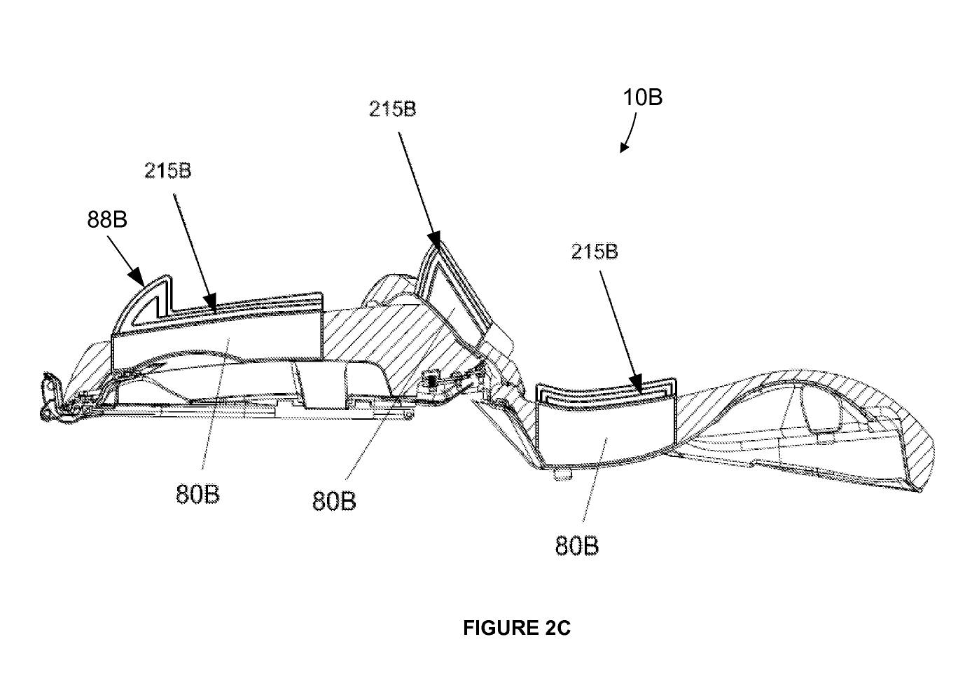

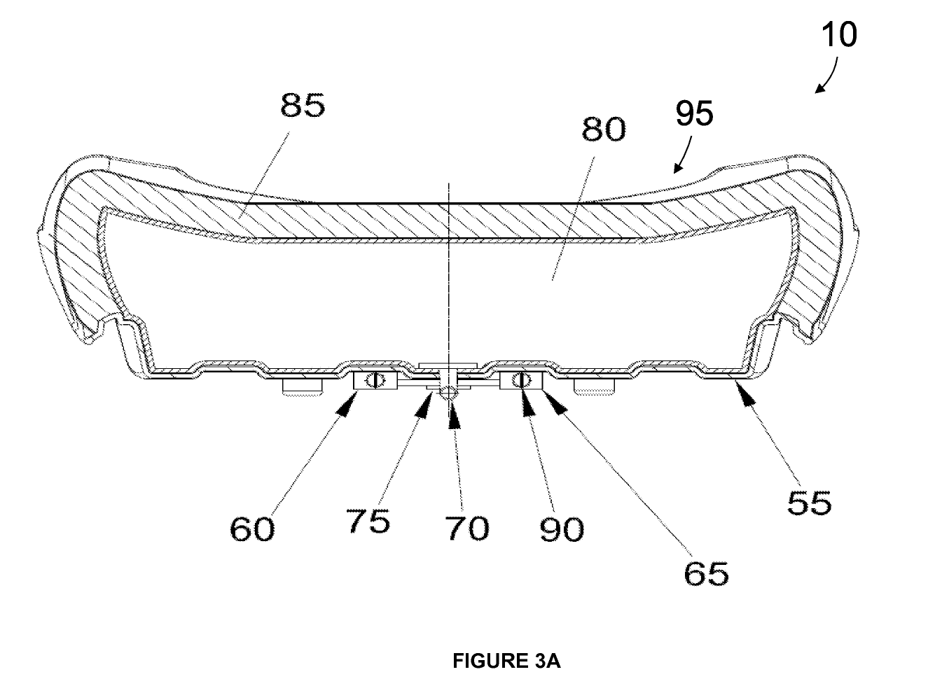

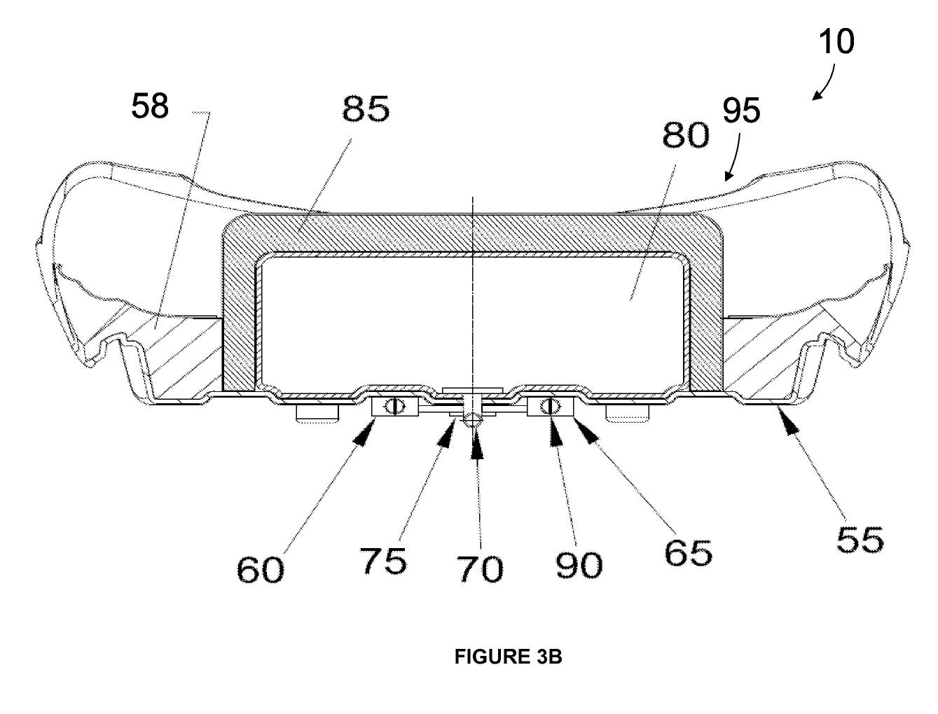

The inflatable seat system 10 includes a rider seat 15, a driver seat backrest 20, and a passenger seat 25. As shown in FIG. 3A, the driver seat 15, driver seat backrest 20, and passenger seat 25 each include a base 55, preferably made of a hard plastic, and seat foam 58. Disposed beneath the base 55 are a first flow control valve 60, a second flow control valve 65, an air inlet valve 70, and a release valve 75. Disposed above the base 55 are air inflatable bladders 80 and cushioning member (e.g., gel pad, memory foam) 85. As shown in FIG. 2B, in an alternative embodiment of an inflatable seat system 10A, in which like elements are identified with the same reference numbers but with an “A” suffix, the passenger seat 25A includes an integrated backrest 88.

The air inflatable bladders 80 are secured upon the base 55 and can be used to adjust height, width, and/or firmness of the seats 15, 25 and backrest 20 with each having its own unique set of characteristics. The air inflatable bladders 80 adjust height, width, and/or firmness of the seats 15, 25 and backrest 20 by means of the air pressure in each bladder 80. The valves 60, 65, 70, 75, which may be coupled to a series of manually operated selector switches 90, form inflation and deflation mechanisms for each bladder 80 to select height, width, and firmness. As shown in FIG. 3A, the valves 60, 65, 70, 75 and switches 90 are preferably located under the seat so as not to be exposed (e.g., hidden in the trunk). Both the forward rider seat 15, driver seat backrest 20, and a passenger seat 25 preferably have their own controls (i.e., individually adjustable).

A seat cover 95 includes a fabric material that is flexible enough to expand and contract with the inflation and deflation combination of the bladders 80 which make up the seats 15, 25 and backrest 20. The seats 15, 25 have a conventional plastic base 55 upon which the horizontal and vertical bladders would be secured to make up the seat 15, 25.

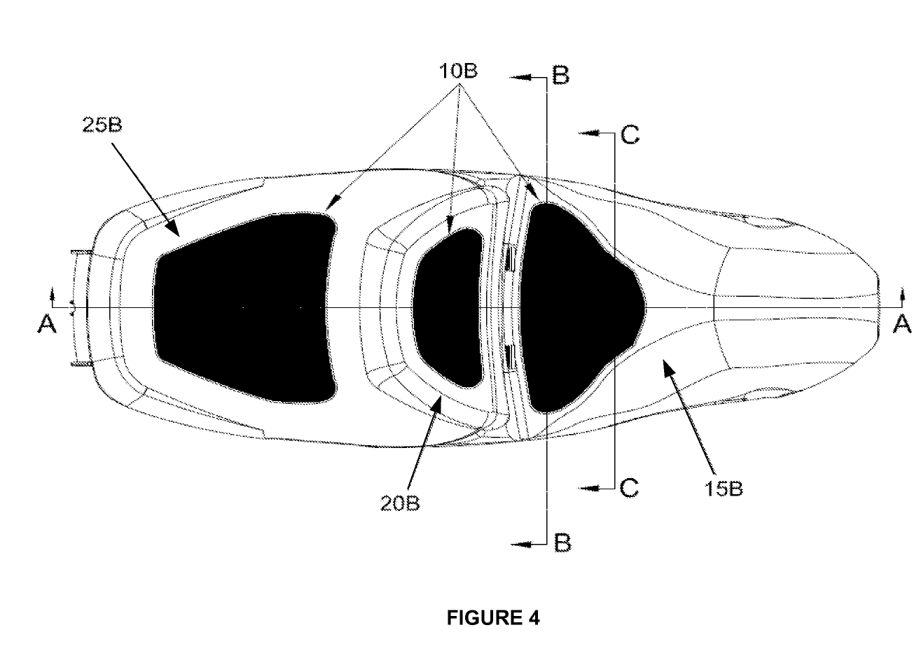

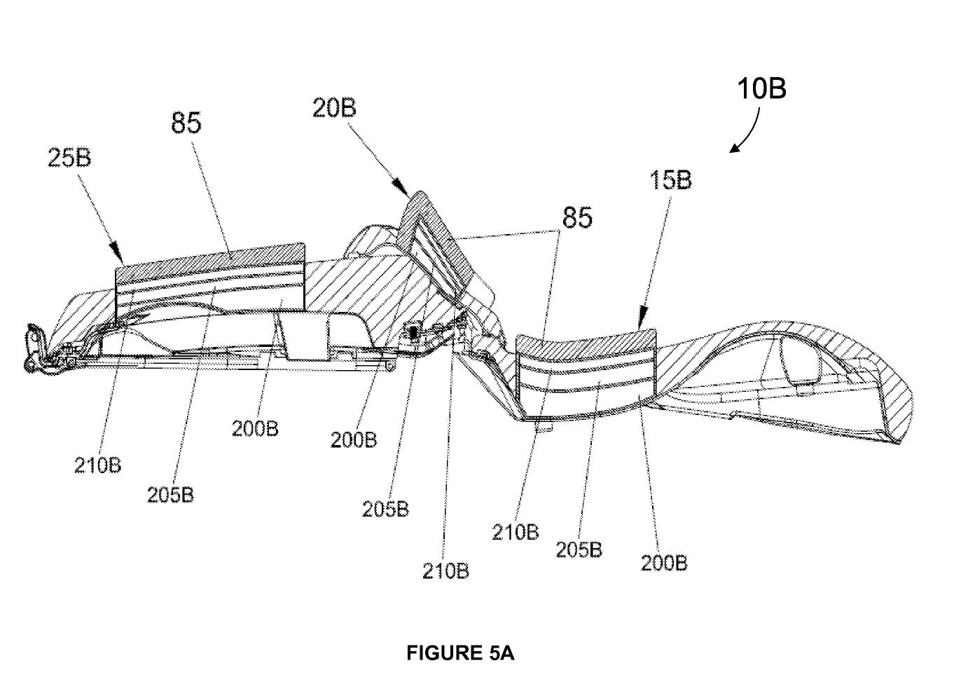

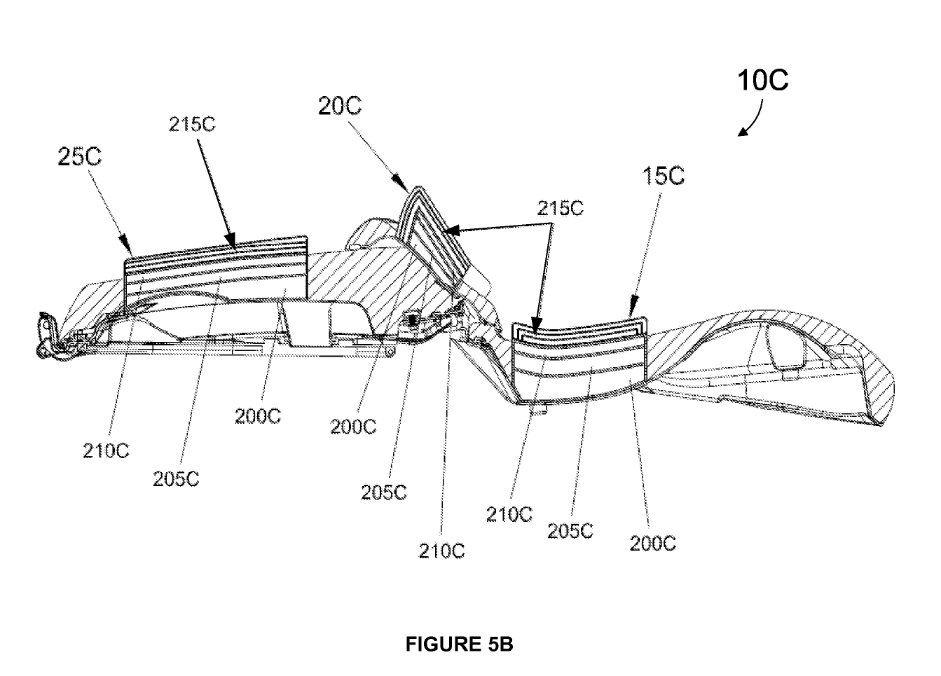

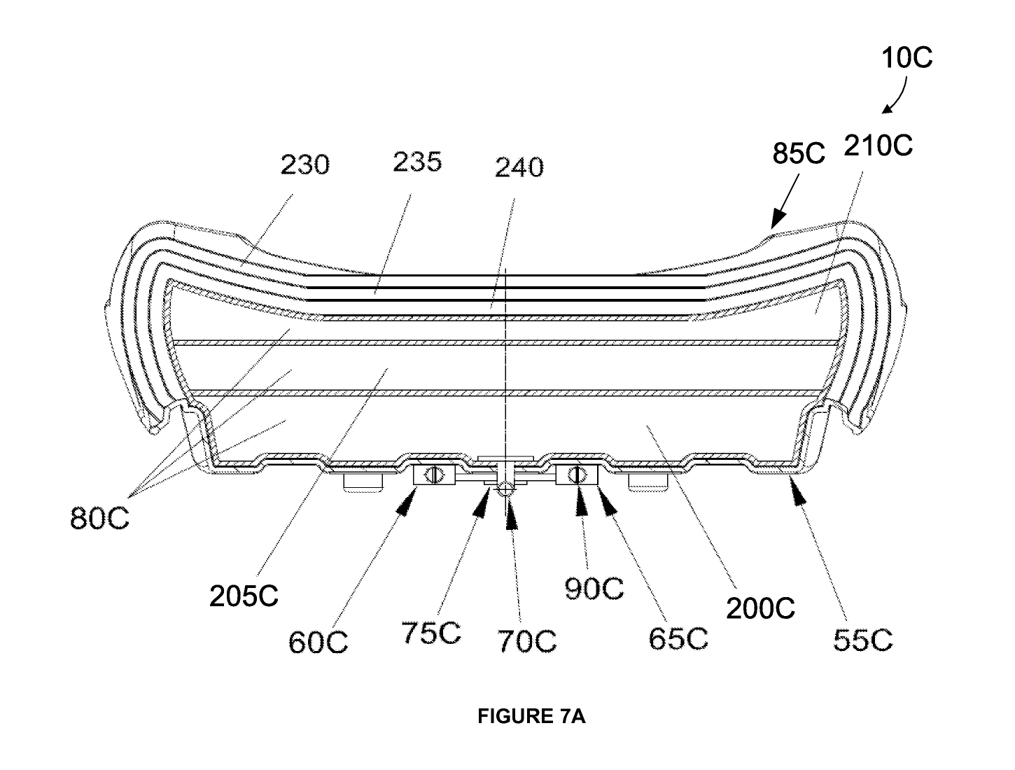

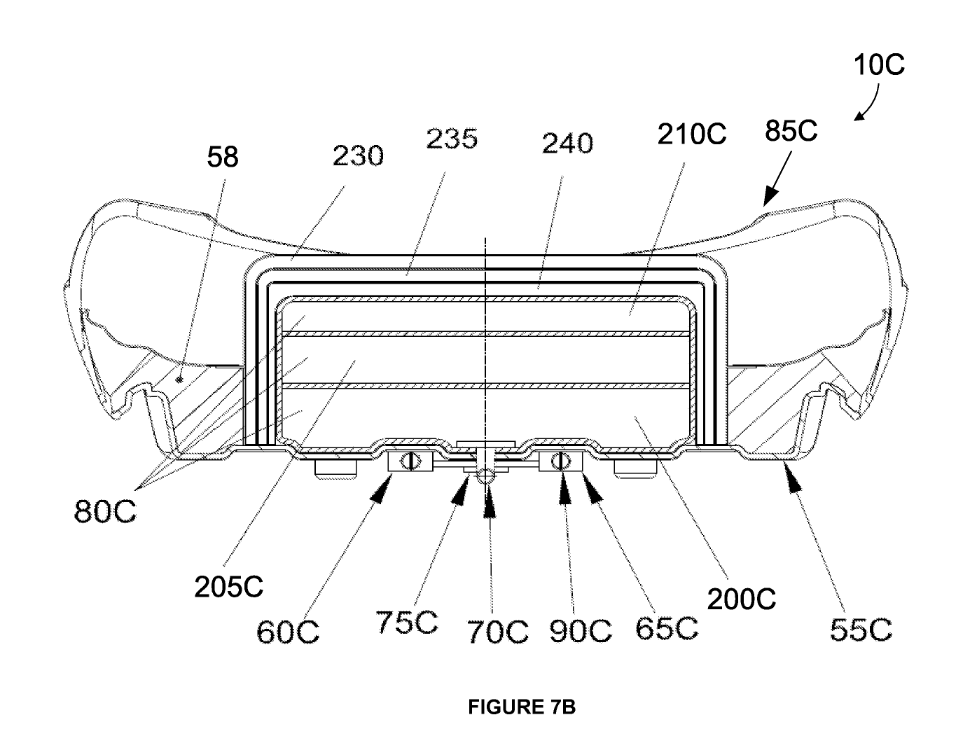

With reference to FIGS. 4, 5A, 6A, and 6B, an alternative embodiment of a seat system 10B will be described. Like elements with those shown and described with respect to FIGS. 1-3B will be identified with the same references numbers, but with a “B” suffix. Instead of a single bladder as shown in the rider seat 15, driver seat backrest 20, and passenger seat 25 of FIGS. 1-3B, the rider seat 15B, driver seat backrest 20B, and passenger seat 25B of FIGS. 4, 5A, 6A, and 6B include vertically layered or stacked bladders 200, 205, 210 disposed above the base 55B and below and/or within the cushioning member (e.g., gel pad, memory foam) 85B. In the embodiment shown, the stacked bladders include a first air bladder section 200, a second air bladder section 205 above the first air bladder section 200, and a third air bladder section 210 above the second air bladder section 205. The cushioning member 85B may include a secondary or fine-tuning air bladder 215 disposed between cushioning member layers 220, 225 (e.g., gel pad, memory foam layers). In alternative embodiments, other numbers of bladders and/or bladder sections (e.g., 1, 2, 3, 4, 5, 6, 7, 8, 9, 10, etc.) are incorporated into one of more of the rider seat 15B, driver seat backrest 20B, and/or passenger seat 25B. For example, as shown in FIGS. 5B, 7A, and 7B, in which like elements are identified with the same reference numbers but with an “C” suffix, cushioning member 85C includes three secondary or fine-tuning air bladder sections 230, 235, 240 dispose over and outward of primary or coarse vertically layered or stacked bladders 200, 205, 210.

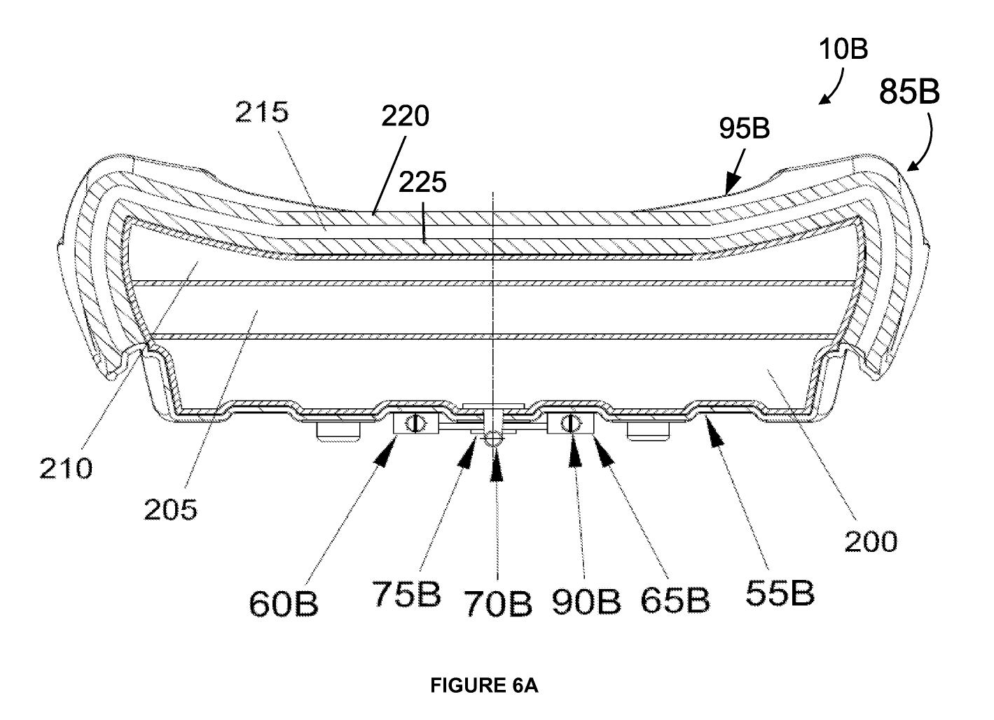

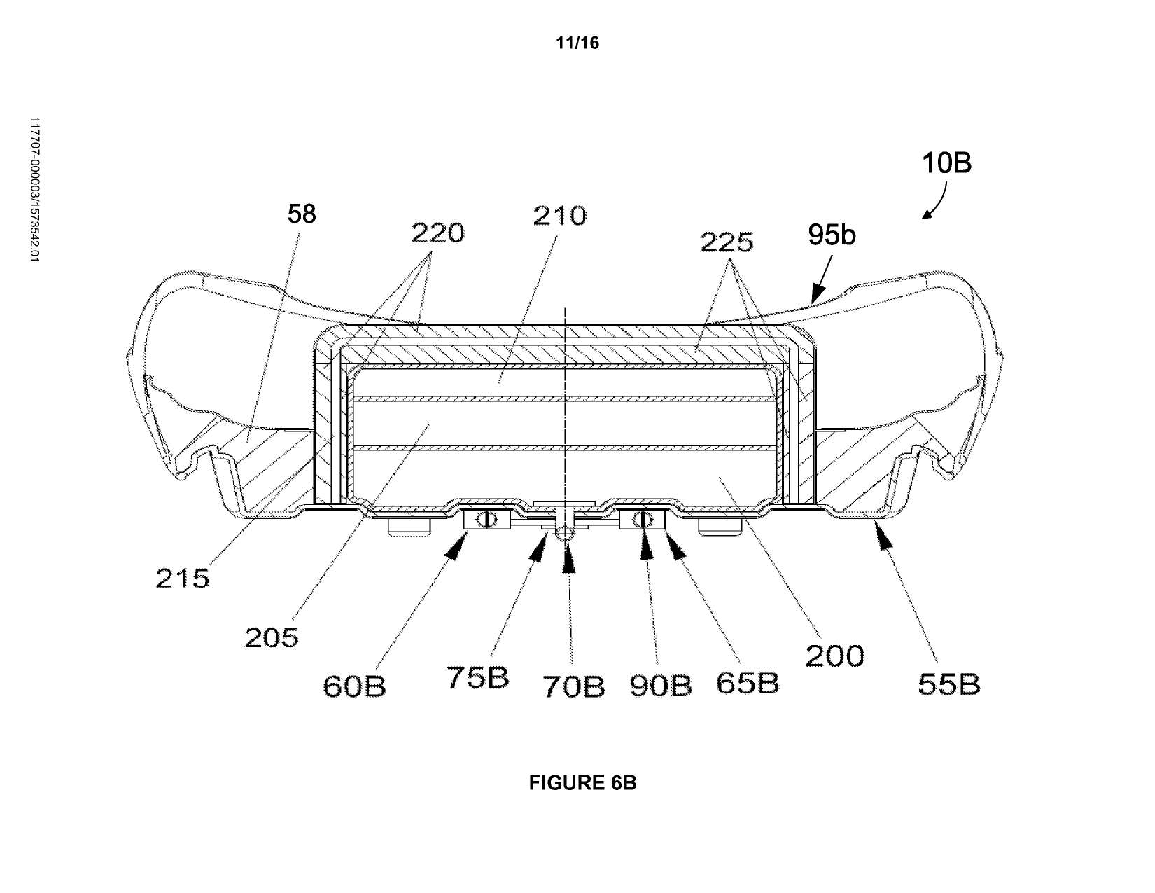

Vertically layering or stacking the air bladders/sections 200, 200C, 205, 205C, 210, 210C provides for an initial “course” or primary adjustment for height, width, and firmness from the inner layer 200B, 205C. As shown in FIGS. 6A and 6B, the single air bladder 215 between cushioning member layers 220, 225 allows for fine or secondary tuning height, width, and/or firmness from the outer layer 85B. As shown in FIGS. 7A and 7B, the multiple secondary or fine air bladder sections 230, 235, 240 allow for even more fine tuning of height, width, and/or firmness from the outer layer 85C compared to outer layer 85B of FIGS. 6A and 6B.

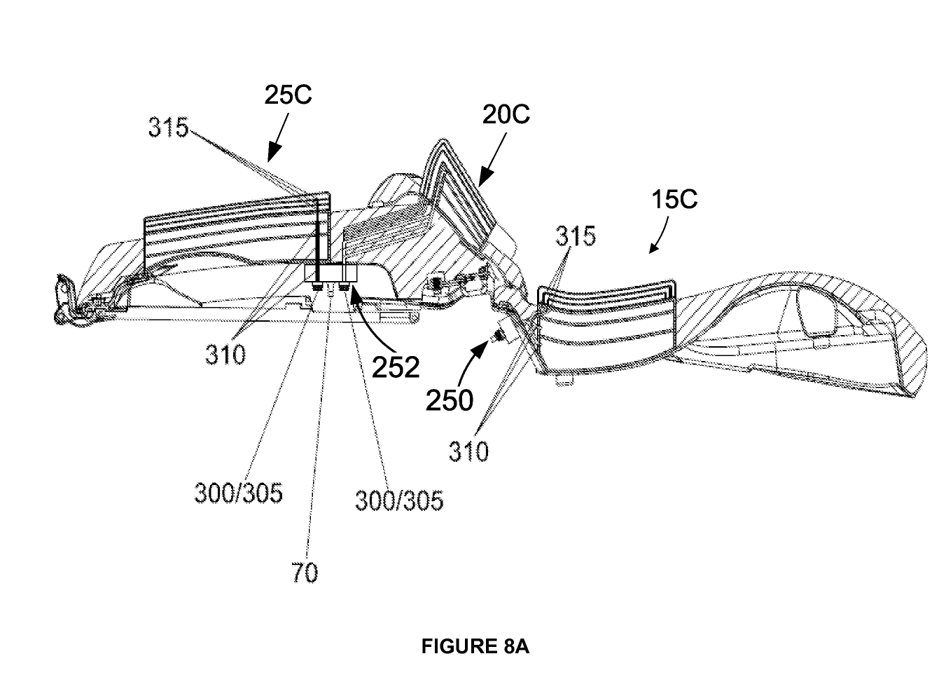

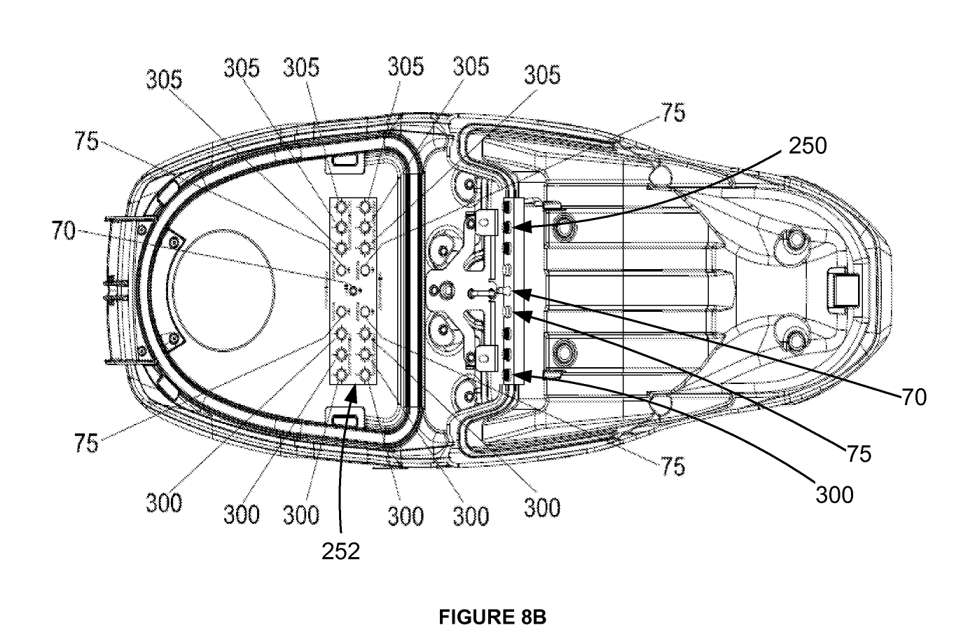

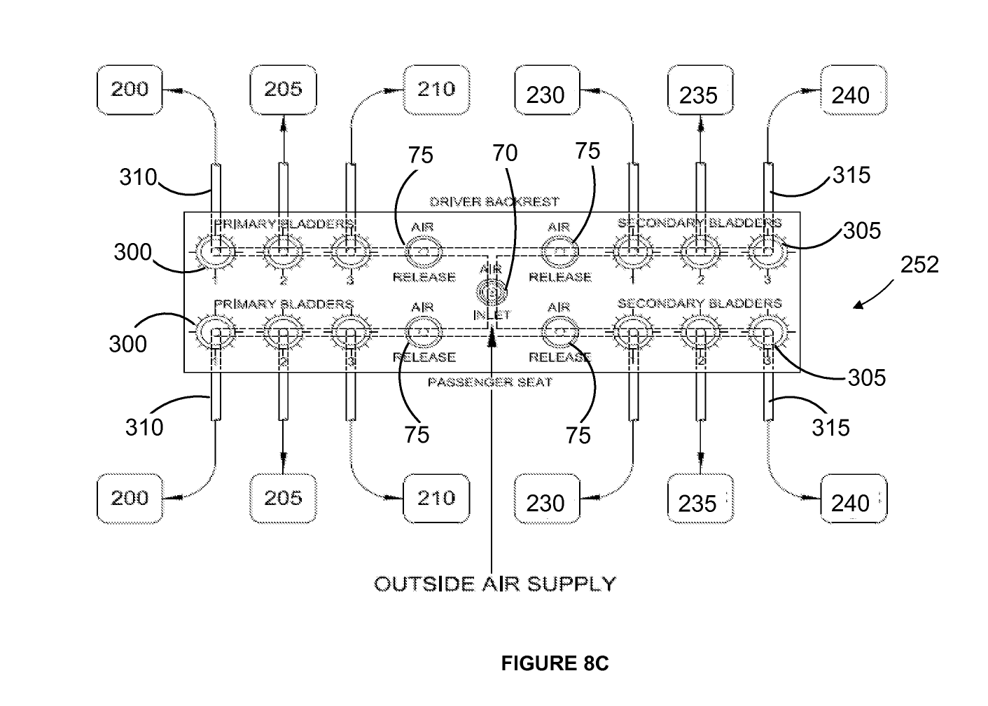

With reference to FIGS. 8A-8C, a driver-seat pneumatic control or inflation and deflation mechanism 250 located underneath the driver seat 15C and driver back rest 20C, and a driver-backrest and passenger-seat pneumatic control or inflation and deflation mechanism 252 located underneath the passenger seat 25C are shown. The pneumatic controls 250, 252 include manual primary/coarse air bladder control valves/switches 300, manual secondary/fine control valves/switches 305, air inlet valves 70, and release valves 75. The pneumatic controls 250, 252 may also include pressure sensors. One or more air pumps (e.g., outside air supply) powered by one or more batteries is/are coupled to the air inlet valve(s) 70 via one or more air tubes for supplying air to the pneumatic controls 250, 252 for controlling height, width, and firmness of each bladder in the seat system. The primary/coarse air bladder control valves/switches 300 respectively control the flow of air to the primary/coarse bladders/sections 200, 200C, 205, 205C, 210, 210C via primary air tubes 310 for coarse adjustment of the height, width, and/or firmness of the driver seat 15C, driver backrest 20C, and passenger seat 25C. Similarly, the secondary/fine/upper air bladder control valves/switches 305 respectively control the flow of air to the secondary or fine-tuning air bladder sections 230, 235, 240 via secondary or fine tuning air tubes 315 for fine tuning the height, width, and/or firmness of the driver seat 15C, driver backrest 20C, and passenger seat 25C. Air may be released from the primary/coarse bladders/sections 200, 200C, 205, 205C, 210, 210C and the secondary/fine/upper air bladder control valves/switches 305 via the release valves 75.

In one or more embodiments and/or implementations, air bladders/sections 200, 200C, 205, 205C, 210, 200C can be pneumatic (air) and air bladder sections 215, 230, 235, and 240 can include one or more of air, nitrogen, gel, and/or foam.

In a further embodiment, once the seat is fitted to the rider, a quick setting foam material is inserted to solidify the customized seat, making the seat configuration permanent if so desired.

In another embodiment, where the inflatable seat system includes an automatic electronic control system including memory, one or more processors/control units, and/or one or more input devices, the adjustments in the individual bladders may be saved in memory and stored for future use. A rider can input his/her profile code and the seat automatically inflates/forms to the rider's profile.

The above figures may depict exemplary configurations for the invention, which is done to aid in understanding the features and functionality that can be included in the invention. The invention is not restricted to the illustrated architectures or configurations, but can be implemented using a variety of alternative architectures and configurations. Additionally, although the invention is described above in terms of various exemplary embodiments and implementations, it should be understood that the various features and functionality described in one or more of the individual embodiments with which they are described, but instead can be applied, alone or in some combination, to one or more of the other embodiments of the invention, whether or not such embodiments are described and whether or not such features are presented as being a part of a described embodiment. Thus the breadth and scope of the present invention, especially in the following claims, should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; and adjectives such as “conventional,” “traditional,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items e present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

What is claimed:

1. An inflatable seat system, comprising:
one or more seats comprising
a seat base;
an inner layer on the seat base;
an outer layer extending over the inner layer,
wherein at least one of the inner layer and the outer layer define a plurality of vertically layered inflatable bladders that are individually adjustably inflatable to adjust one or more of height, width, and firmness in the seat system.

2. The inflatable seat system of claim 1, further including one or more inflation and deflation mechanisms to individually adjustably inflate and deflate the plurality of vertically layered inflatable bladders.

3. The inflatable seat system of claim 1, wherein the one or more inflation and deflation mechanisms are located under the seat base.

4. The inflatable seat system of claim 1, wherein the one or more seats include a forward rider seat and a rear passenger seat.

5. The inflatable seat system of claim 1, wherein the outer layer includes fabric material flexible enough to expand and contract with the inflation and deflation of the bladders.

6. The inflatable seat system of claim 1, wherein the inner layer defines the plurality of vertically layered inflatable bladders for providing a coarse adjustment for at one or more of height, width, and firmness of the seat.

7. The inflatable seat system of claim 6, wherein the plurality of vertically layered inflatable bladders defined by the inner layer are pneumatic.

8. The inflatable seat system of claim 1, wherein the outer layer defines the plurality of vertically layered inflatable bladders for providing a fine adjustment for one or more of height, width, and firmness of the seat.

9. The inflatable seat system of claim 8, wherein the one or more vertically layered inflatable bladders defined by the outside layer include one or more of air, nitrogen, gel, and foam.

10. The inflatable seat system of claim 1, further including an electronic control system having memory and wherein adjustments in the plurality of vertically layered inflatable bladders are saved in memory and stored for future use.

11. The inflatable seat system of claim 10, further including an input device that a rider can input a rider's profile into so that the seat automatically inflates or deflates to the rider's profile.

12. The inflatable seat system of claim 1, wherein the inner layer defines the plurality of vertically layered inflatable bladders for providing a coarse adjustment for one or more of height, width, and firmness of the seat and the outer layer defines one or more vertically layered inflatable bladders for providing a fine adjustment for one or more of height, width, and firmness of the seat.

13. The inflatable seat system of claim 1, wherein the inner layer includes a single inflatable bladder for coarse adjustment of one or more of height, width, and firmness of the seat and the outer layer includes a single inflatable bladder for fine adjustment of one or more of height, width, and firmness of the seat.
